(19) United States
(12) Patent Application Publication
(10) Pub. No.: US 2008/0085491 A1
(43) Pub. Date: Apr. 10, 2008

(54) Dental implant system

(76) Inventor: Chih-Chung Ho, Kaohsiung (TW)

Correspondence Address: SUGHRUE MION, PLLC, 2100 PENNSYLVANIA AVENUE, N.W., SUITE 800, WASHINGTON, DC, 20037, US

(21) Appl. No.: 11/544,731

(22) Filed: Oct. 10, 2006

(51) Int. Cl. A61C 8/00

(52) U.S. Cl. 433/173

(57) ABSTRACT

The present invention relates to a dental implant. The dental implant comprises: a central portion, at least one proximal plate-like projection, at least one fin and at least one protrusion. The central portion has a first section and a second section. The protrusion is disposed on a clearance side of the first section, the clearance side does not have the proximal plate-like projection, the protrusion has an isthmus. The dental implant of the present invention pays more attention to the horizontal force. According to the present invention, the protrusion with the isthmus is suggested to be placed toward the non-horizontal-force-bearing side. The dental implant of the present invention can catch the bony structure behind the proximal plate-like projection. Combine with the proximal plate-like projection, the dental implant can catch maximum bony structure to resist horizontal force.

### BACKGROUND OF THE INVENTION

1. Field of the Invention

The present invention relates to a dental implant, more particularly, a dental implant with an isthmus on protrusion.

2. Description of the Related Art

The occlusal force can be divided into vertical force and horizontal force. The vertical force for the implant is the compression force at the bottom and the shearing force at the lateral. The horizontal force is a tipping force for the implant, which means both the ends are most forced, with different directions.

Because the horizontal force toward the proximal side is co-bolstered by the adjacent teeth (or implants), such force is less detrimental to the alveolar bone. The dental implant catches the bone to resist the occlusal force. Therefore, to have implants catch enough alveolar bone for the occlusal force, yet keep the alveolar bone from being destroyed is the basic and most important consideration for dental implant design.

Since the advent of titanium dental implant, many dental implants have the shape of natural root lingered. But as a matter of fact, the supporting mechanisms of the natural tooth and that of the implant are not the same. The natural tooth is suspended in the bone by the ligaments, the implant is “fixed” to the bone. Mimicking the morphology of the root of the tooth does not make sense.

Referring to FIG. 1, the conventional dental implant 80 comprises a central portion 81 and a plurality of fins 83. The central portion 81 is a tapering shape cylinder. Tapering of the central portion 81 of the dental implant 80 would reduce the capability to resist the vertical force and the horizontal force. And as is seen clinically, the deeper portion of alveolar bone always has ample space of the implant. Another drawback for many contemporary implants is the threads or fins 83. The threads or fins are basically horizontal projections from the central portion 81. The fins (horizontal projections) catch bone in such manners that they are significantly less equipped for horizontal forces than for vertical forces. This may explain why the successful rate of implant in the maxilla is always lower than that in the mandible. The implants in the maxilla receive more horizontal force than those in the mandible. Compared with the lower anterior, the upper anterior is always bigger than its lower counterpart, which may imply that horizontal force is more difficult to deal with.

U.S. Pat. No. 4,738,623 discloses a dental implant system considered by many dentists one of the best implant systems, also has the disadvantages mentioned above. Like other implant, the entrance to the bone is the most vulnerable. The conventional dental implant deals with the problem seriously. According to it's manual, the conventional dental implant is implanted 1 mm˜2 mm below the alveolar crest. Later, some of the bone is removed, and the abutment and crown is connected to the conventional dental implant. But as is clinically observed, in the long run the bone would retreat to the shoulder of the conventional dental implant. Although the material of the implant and that of the abutment post are the same, the abutment post doesn't get osseointegrated. Maybe there is micro-rotation of the abutment post. An un-osseointegrated post in the bone is a highway for the hostile bacteria. In some cases, the bony deteriorations continued, and the implant exposures were inevitable. The exposures were often on the horizontal-force-bearing side. Such exposure would embarrass the patient and leave an ordeal for the dentist.

Furthermore, it seems to be a mystery that a class I occlusion, when turns into edentulous, finally has a class III bony relationship. But if you take the horizontal force (of occlusion) into consideration, the outcome is not surprising. Most of the horizontal force exerts on the upper buccal side of maxilla, and on the upper lingual side of mandible. When the tooth is lost, the upper alveolar plate that bears the force disappears faster than the opposite side that does not bear the force. The horizontal forces have certain directions.

### SUMMARY OF THE INVENTION

Before the description of the dental implant of the invention, some terminology must be clearly defined. The term “lower” is not related to gravity, it means in the deeper bone, and “upper” means it's proximal to the gingiva or crown. And “buccal” means buccal or facial, “lingual” means lingual or palatal. “Vertical” means in the direction along with the longitudinal axis of the dental implant, “horizontal” means in the direction that is perpendicular to “vertical”. “Front” is toward the horizontal-force-bearing side; “Rear” is toward the non-horizontal-force-bearing side.

The present invention relates to a dental implant. The dental implant comprises: a central portion, at least one proximal plate-like projection, at least one fin and at least one protrusion. The central portion has a first section, a second section, a horizontal direction and a vertical direction. The proximal plate-like projection projects from the first section of the central portion along the horizontal direction and extends along the vertical direction. The fin projects from the second section of the central portion along the horizontal direction. The protrusion is disposed on a clearance side of the first section, the clearance side has no the proximal plate-like projection, the protrusion has an isthmus.

The dental implant of the present invention pays more attention to the horizontal force that is usually ignored by other systems. According to the present invention, the protrusion with the isthmus is suggested to be placed toward the non-horizontal-force-bearing side, therefore the dental implant of the present invention can catch the bony structure behind the proximal plate-like projection. Combine with the proximal plate-like projection, the dental implant can catch maximum bony structure to resist horizontal force.

### BRIEF DESCRIPTION OF THE DRAWINGS

FIG. 1 is a conventional dental implant of the prior art after healing.

FIG. 2a is a proximal side elevational view of a dental implant according to a first embodiment of the invention.

FIG. 2b is a buccal side elevational view of the dental implant according to the first embodiment of the invention.

FIG. 2c is a downward perspective view of the dental implant according to the first embodiment of the invention.

FIG. 2d is a top plan view of the dental implant according to the first embodiment of the invention.

FIG. 2e is an upward perspective view of the dental implant according to the first embodiment of the invention.

FIG. 2f shows the dental implant according to the first embodiment of the invention after healing.

FIG. 3a is a proximal side elevational view of a dental implant according to a second embodiment of the invention.

FIG. 3b is a buccal side elevational view of the dental implant according to the second embodiment of the invention.

FIG. 3c is a downward perspective view of the dental implant according to the second embodiment of the invention.

FIG. 3d is a top plan view of the dental implant according to the second embodiment of the invention.

FIG. 3e is an upward perspective view of the dental implant according to the second embodiment of the invention.

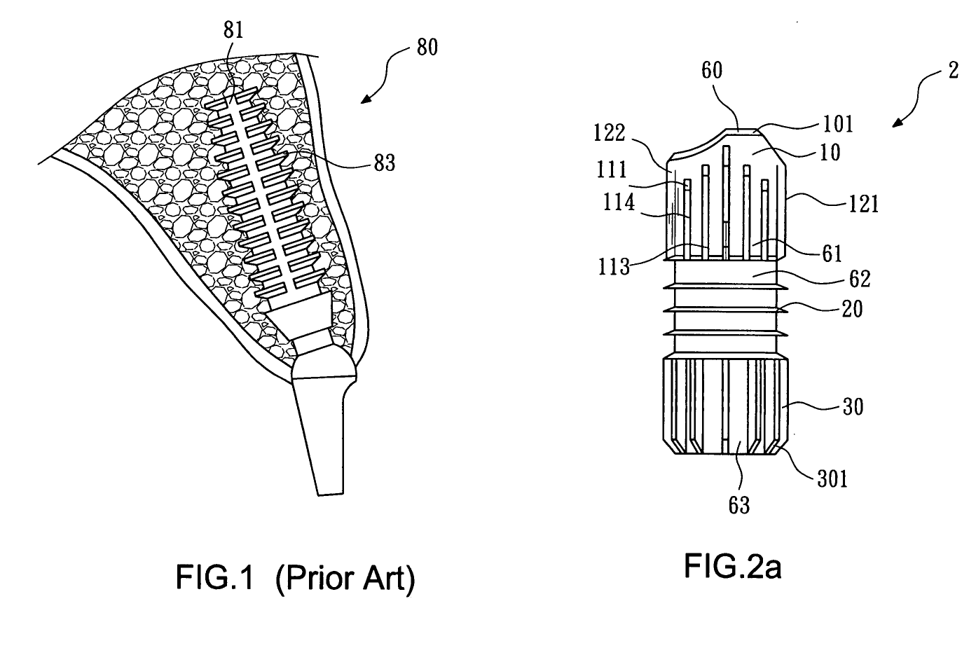

### DETAILED DESCRIPTION OF THE INVENTION

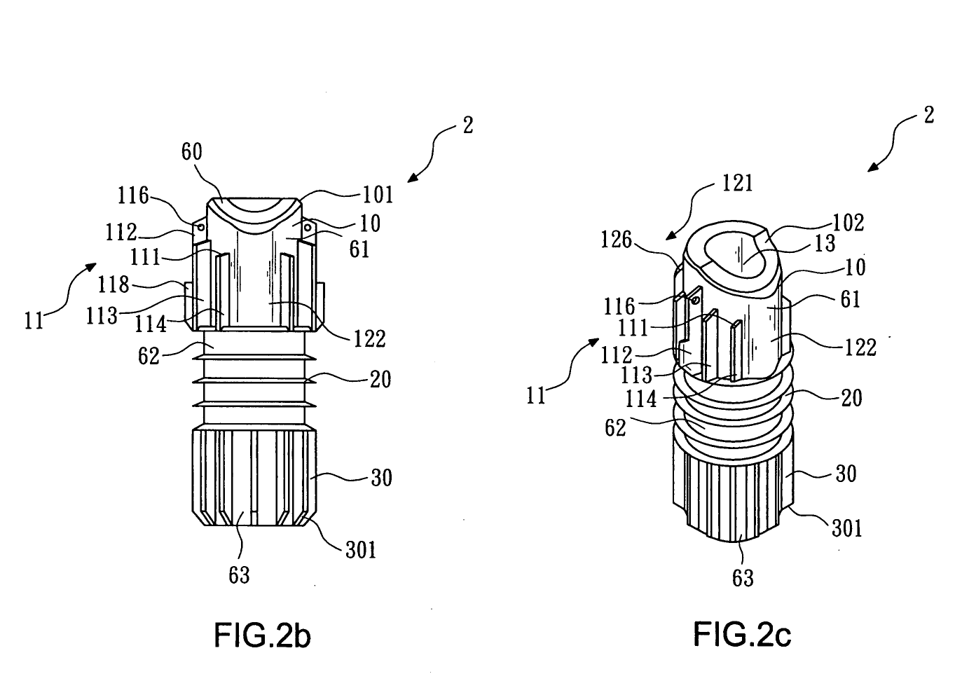

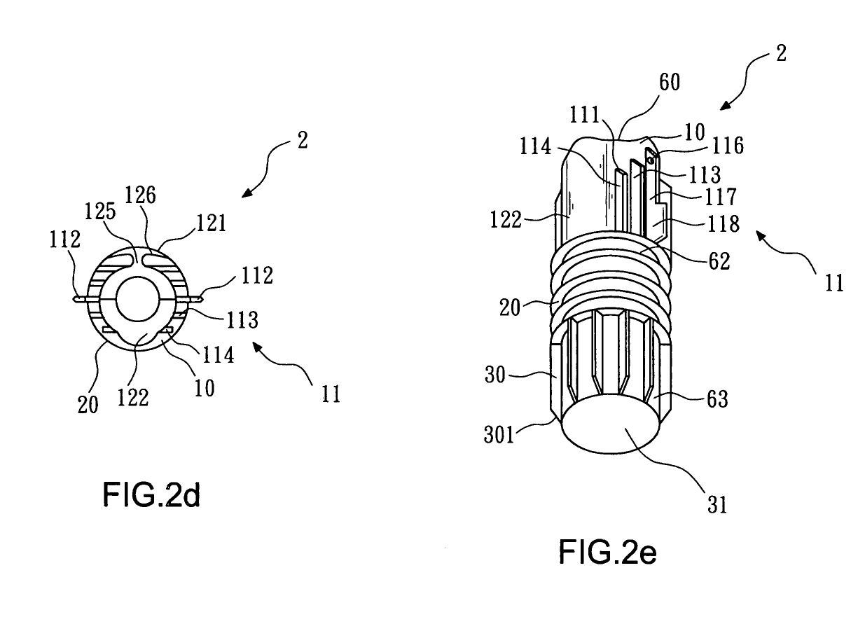

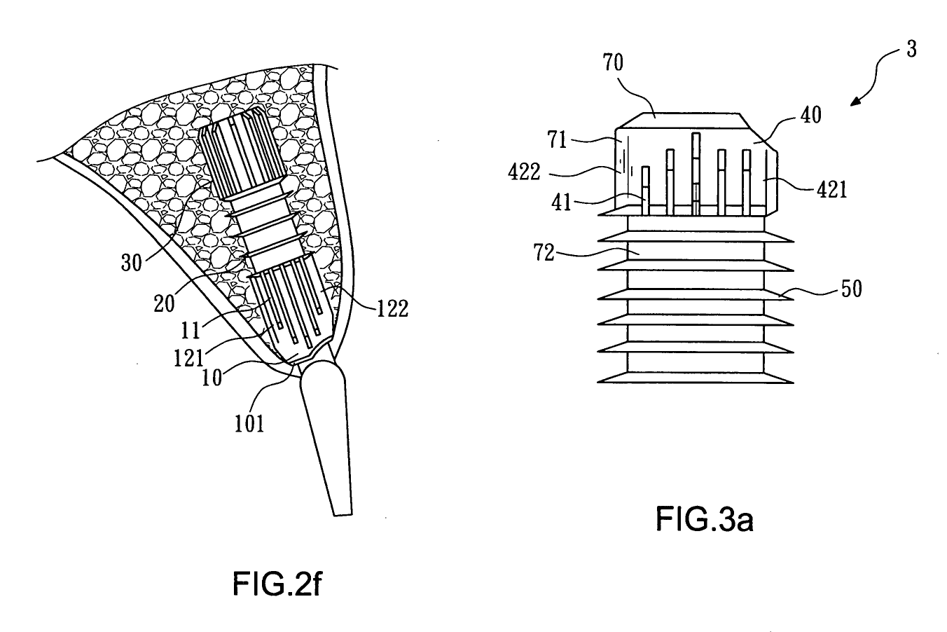

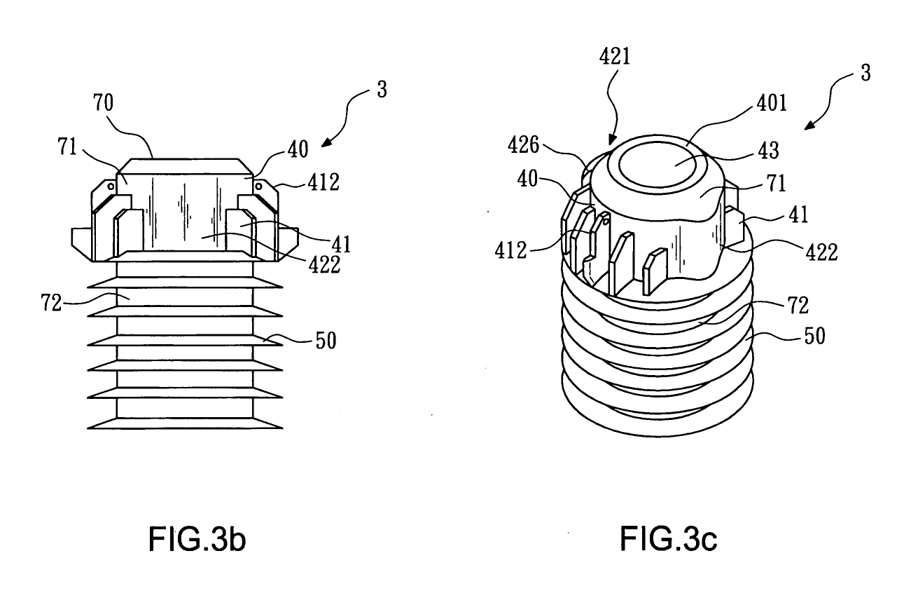

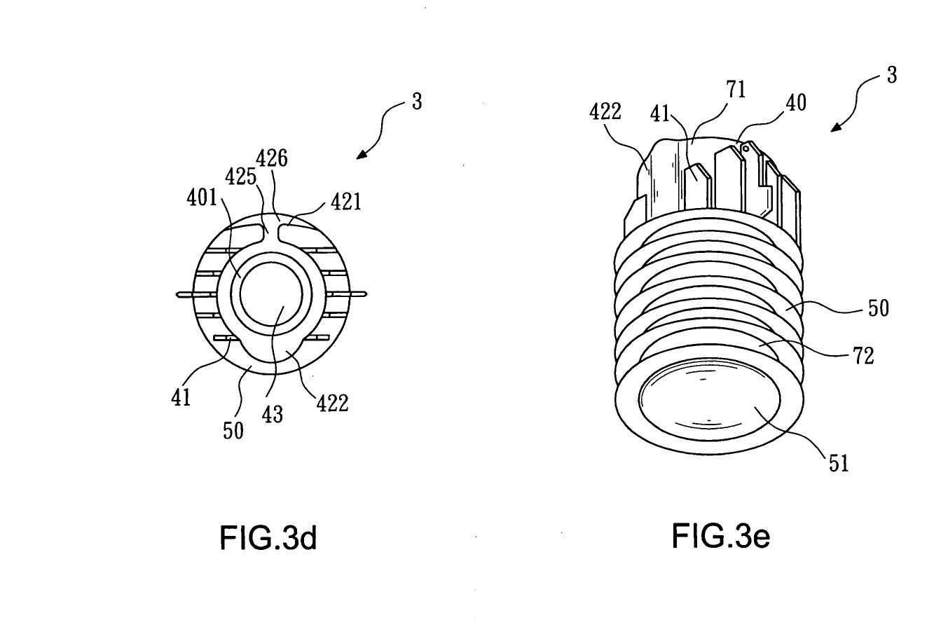

Referring to FIGS. 2a, 2b, 2c, 2d, 2e and 2f, they show a dental implant according to a first embodiment of the invention. The dental implant 2 that would receive more horizontal force than vertical force (from occlusion) is named Type A implant. Generally the Type A implant would be for the maxillary anteriors. Referring to FIGS. 3a, 3b, 3c, 3d and 3e, they show a dental implant according to a second embodiment of the invention. The dental implant 3 that would receive more vertical force is named Type B implant.

The dental implant of the present invention is generally a cylindrical and un-tapered implant that is later to connect an abutment for the prosthesis. The dental implant of the present invention is supposed to be tapped or knocked into the bony socket.

Referring to FIGS. 2a to 2f again, the dental implant 2 comprises: a central portion 60, at least one upper proximal plate-like projection 11, at least one fin 20, at least one lower proximal plate-like projection 30 and at least one protrusion 121 and 122. The central portion 60 has a first section 61, a second section 62, a third section 63, a horizontal direction and a vertical direction. In the embodiment, the central portion 60 is a cylindrical shape and is not tapered.

The central portion 60 further comprises a neck 10 disposed on the first section 61. The height of the neck 10 is about 0.5 mm to 3.0 mm. The neck 10 has an edge 101 with some rounding, and the edge 101 is inward and upward to the longitudinal axis of the dental implant. The neck 10 had better be as narrow as possible if it's mechanically approved. With such design the neck 10 has a rim 102, and the rim 102 on the neck 10 would be narrow. The rim 102 toward the buccal side is trimmed to simulate the curvature of buccal gingival. The trimming rim 102 begins from proximal sides downwardly to the buccal side, and is preferably concave. The trimming rim 102 would allow the surgeon not to bury the implant deep in the bone without worrying the exposure of dental implant on the buccal side. And the trimming rim 102 is preferably to match the asymmetrically resorbed ridge. The depth of the trimming rim 102 is between 0.5 mm to 2 mm.

Following the neck 10 are the upper proximal plate-like projection 11 and the buccal and lingual clearances. The upper proximal plate-like projection 11 projects from the first section 61 of the central portion 60 along the horizontal direction, and extends along the vertical direction. In the embodiment, a plurality of upper proximal plate-like projections are mounted on the first section 61 of the central portion 60. The upper proximal plate-like projections 11 preferably are comprehensively pruned at the upper edge to form pruned upper edges 111.

The upper proximal plate-like projection 11 is disposed on a proximal side of the first section 61, and the first section 61 has a buccal clearance and a lingual clearance without the upper proximal plate-like projection, the buccal and lingual clearances are respectively disposed on a buccal side and a lingual side of the first section 61. That is, on the buccal and lingual sides at the level of the upper plate-like projection 11, there are no upper proximal plate-like projections.

In this embodiment, the dental implant 2 comprises a first protrusion 121 and a second protrusion 122, and the first protrusion 121 and the second protrusion 122 are disposed on the lingual and buccal clearance sides of the first section 61 respectively. The first protrusion 121 comprises an isthmus 125 and an enlarged portion 126. The enlarged portion 126 extends from the isthmus 125, and the shape of the enlarged portion 126 is corresponding to the shape of a drilled socket for the dental implant 2. The first protrusion 121 is disposed on a non-horizontal-force-bearing side (lingual), and the second protrusion is disposed on a horizontal-force-bearing side. The non-horizontal-force-bearing side is generally a lingual side of maxilla, or the non-horizontal-force-bearing side is generally a buccal side of mandible.

According to the invention, the protrusion with isthmus is suggested to be placed toward the non-horizontal-force-bearing side. The dental implant of the present invention can catch the bony structure behind the proximal plate-like projection. Combine with the proximal plate-like projection, the dental implant can catch maximum bony structure to resist horizontal force.

The dental implant of the invention effectively deals with the horizontal force by the proximal plate-like projections 11 which are surrounded by ample bony structure. Thus the chance of bony deterioration is reduced. The length of the first section 61 with the upper proximal plate-like projection is about ¼ to ⅖ of the total length of the central portion 60. Because the horizontal force is least felt in the middle section of the central portion, the plate-like projections do not appear in the middle section of the central portion.

The proximal plate-like projections comprise at least one positioning proximal plate-like projection 112. The positioning proximal plate-like projection 112 has a normal part 117 and a lower part 118. The width of the normal part 117 of the positioning proximal plate-like projection 112 is equal to that of the proximal plate-like projection 11. The lower part 118 of the positioning proximal plate-like projection 112 extends outside the outer diameter of the fin 20. Therefore, the width of the lower part 118 of the positioning proximal plate-like projection 112 is bigger than the other proximal plate-like projections 11. In the embodiment, there are two positioning proximal plate-like projection 112 disposed on the proximal sides for positioning the dental implant 2. The proximal plate-like projections 112 are designed to keep the dental implant in the bone with correct direction which will significantly reduce the chance of rotation after surgery. The lower and lateral edges of the lower part 118 are sharp, and the upper edge of the lower part 118 is dull. The lower part 118 of the positioning proximal plate-like projection 12 preferably is comprehensively pruned at the lower edge to form a pruned lower edge, and the pruned lower edge of the lower part is sharp. The sharp edges of the positioning plate-like projections 12 make the insertion of the implant easier and the dull edges make the implant has less chance to exfoliate.

Furthermore, the proximal plate-like projections comprise at least one pulling proximal plate-like projection 112. In the embodiment, the positioning proximal plate-like projection is the pulling proximal plate-like projection. The length of the pulling proximal plate-like projection 112 is higher than other proximal plate-like projections. The pulling proximal plate-like projection 112 has a pulling hole 116 for receiving a pulling device to pull the dental implant 2 in case of any unwanted insertion depth during surgery. Besides, the pulling proximal plate-like projection may have a pulling groove for receiving a pulling device to pull the dental implant.

The proximal plate-like projections 11 comprise at least one normal proximal plate-like projection 113. In the embodiment, the length of the normal proximal plate-like projection 113 is lower than that of the pulling proximal plate-like projection 112; and the width of the normal proximal plate-like projection 113 is smaller than that of the lower part 118 of the positioning proximal plate-like projection 112. That is, the width of the normal proximal plate-like projection 113 is equal to the outer diameter of the fin 20.

The proximal plate-like projections 11 comprise at least one small proximal plate-like projection 114. In the embodiment, the length of the small proximal plate-like projection 114 is lower than that of the normal proximal plate-like projection 113; and the width of the small proximal plate-like projection 114 is smaller than that of the normal proximal plate-like projection 113.

Therefore, the length of the proximal plate-like projections 11 is gradually lower from the pulling proximal plate-like projection 112 to the small proximal plate-like projection 114, and the width of the proximal plate-like projections 11 is gradually smaller from the lower part 118 of the positioning proximal plate-like projection 112 to the small proximal plate-like projection 114.

Next to the plate-like projections 11, the fin 20 projects from the second section 62 of the central portion 60 along the horizontal direction. In the embodiment, a plurality of fins are circularly mounted on the peripheral of the second section 62 of the central portion 60. The fins 20 are not tapered. The length of the second section 62 with the fins is about ⅕ to ½ of the length of the central portion 60.

The lower proximal plate-like projection 30 is disposed on the third section 63 of the central portion 60. The length of the third section 63 with the lower proximal plate-like projection is about ¼ to ⅖ of the total length of the central portion 60. The projecting angels of the lower proximal plate-like projection are suggested to be perpendicular to the tangent of the central portion 60. The lower proximal plate-like projection 30 has a pruned lower edge 301. The pruned lower edge 301 preferably is sharp. Near a bottom 31 of the central portion 60, the edges of the plate-like projections 30 are pruned to match the bottom of the bony socket; that is, to match the shape of the drill.

The central portion 60 further comprises the bottom 31 and a well 13. The bottom 31 is flat. The well 13 is going to be connected to the abutment and has an opening at the top of the central portion 60.

Referring to FIGS. 3a, 3b, 3c, 3d and 3e, the dental implant 3 comprises: a central portion 70, at least one proximal plate-like projection 41, at least one fin 50 and at least one protrusion 421, 422. The central portion 70 has a first section 71, a second section 72, a horizontal direction and a vertical direction. The central portion 70 further comprises a neck 40 disposed on the first section 71. The neck 40 of the second embodiment is similar to the neck 10 of the first embodiment. But the neck 40 here is shorter. The neck 40 comprises a rim 401. The rim 401 is flat or is less trimmed. The length of the neck 40 is between 0.5 to 2 mm and the depth of trimming rim is suggested to be 0.5 to 1.2 mm.

The proximal plate-like projection 41 projects from the first section 71 of the central portion 70 along the horizontal direction, and extends along the vertical direction. The proximal plate-like projections 41 and the protrusion 421, 422 on buccal and lingual sides are also similar to the previous description in the first embodiment. The first protrusion 421 comprises an isthmus 425 and an enlarged portion 426. But the ratio differs. The length of the first section 71 with the proximal plate-like projection 41 is about ⅙ to ⅖ of the total length of the central portion 70. The positioning proximal plate-like projection and the pulling proximal plate-like projection 412 is similar to the previous description in the first embodiment.

The fin 50 projects from the second section 72 of the central portion 70 along the horizontal direction. The central portion 70 further comprises a bottom 51 and a well 43. The fins 50 go down to the bottom 51 without shrinking their diameters. The bottom 51 is concave. The bone at the bottom receives a lot of compression force. The concave bottom 51 disperses the force. This is especially important for the short dental implant with large diameter. It needs a drill specially designed to shape the bottom of the bony socket if any length deeper is crucial.

While the embodiments of the present invention have been illustrated and described, various modifications and improvements can be made by those skilled in the art. The embodiments of the present invention are therefore described in an illustrative, but not restrictive, sense. It is intended that the present invention may not be limited to the particular forms as illustrated, and that all modifications which maintain the spirit and scope of the present invention are within the scope as defined in the appended claims.

1. A dental implant, comprising:
a central portion, having a first section, a second section, a horizontal direction and a vertical direction;
at least one proximal plate-like projection, projecting from the first section of the central portion extending along the vertical direction;
at least one fin, projecting from the second section of the central portion along the horizontal direction; and
at least one protrusion, disposed on a clearance side of the first section, the clearance side without the proximal plate-like projection, the protrusion having an isthmus.

2. The dental implant according to claim 1, wherein the proximal plate-like projection is disposed on a proximal side of the first section, and the first section has a buccal clearance and a lingual clearance without the proximal plate-like projection, the protrusions are respectively disposed on a buccal side and a lingual side of the first section.

3. The dental implant according to claim 2, wherein the dental implant comprises a first protrusion and a second protrusion, the first protrusion comprises the isthmus and an enlarged portion, the enlarged portion extends from the isthmus, the first protrusion is disposed on a non-horizontal-force-bearing side and the second protrusion is disposed on a horizontal-force-bearing side.

4. The dental implant according to claim 3, wherein the shape of the enlarged portion is corresponding to the shape of a drilled socket for the dental implant.

5. The dental implant according to claim 1, wherein the proximal plate-like projection has a pruned upper edge.

6. The dental implant according to claim 1, wherein the proximal plate-like projections comprise at least one upper proximal plate-like projection and at least one lower proximal plate-like projection, the central portion further comprises a third section, the upper proximal plate-like projection is disposed on the first section and the lower proximal plate-like projection is disposed on the third section.

7. The dental implant according to claim 6, wherein the lower proximal plate-like projection has a pruned lower edge.

8. The dental implant according to claim 1, wherein the proximal plate-like projections comprise at least one positioning proximal plate-like projection, the positioning proximal plate-like projection has a normal part and a lower part, the lower part of the positioning proximal plate-like projection extends outside the outer diameter of the fin.

9. The dental implant according to claim 1, wherein the proximal plate-like projections comprise at least one pulling proximal plate-like projection, the length of the pulling proximal plate-like projection is higher than the other proximal plate-like projections.

10. The dental implant according to claim 9, wherein the pulling proximal plate-like projection has a pulling hole.

11. The dental implant according to claim 9, wherein the pulling proximal plate-like projection has a pulling groove.

12. The dental implant according to claim 9, wherein the proximal plate-like projections comprise at least one normal proximal plate-like projection, the width of the normal proximal plate-like projection is equal to the outer diameter of the fin, the length of the normal proximal plate-like projection is lower than that of the pulling proximal plate-like projection.

13. The dental implant according to claim 12, wherein the proximal plate-like projections comprise at least one small proximal plate-like projection, the length of the small proximal plate-like projection is lower than that of the normal proximal plate-like projection; and the width of the small proximal plate-like projection is smaller than that of the normal proximal plate-like projection.

14. A dental implant, comprising:
a central portion, having a first section, a second section, a horizontal direction and a vertical direction;
at least one fin, projecting from the second section of the central portion along the horizontal direction; and
at least one proximal plate-like projection, projecting from the first section of the central portion extending along the vertical direction, the proximal plate-like projection having at least one positioning proximal plate-like projection, the positioning proximal plate-like projection having a normal part and a lower part, the lower part of the positioning proximal plate-like projection extending outside the outer diameter of the fin.

15. The dental implant according to claim 14, wherein the dental implant further comprises at least one protrusion, the protrusion is disposed on a clearance side of the first section, the clearance side without the proximal plate-like projection, the protrusion has an isthmus, the proximal plate-like projection is disposed on a proximal side of the first section, and the first section has a buccal clearance and a lingual clearance without the proximal plate-like projection, the protrusions are respectively disposed on a buccal side and a lingual side of the first section.

16. The dental implant according to claim 15, wherein the dental implant comprises a first protrusion and a second protrusion, the first protrusion comprises the isthmus and an enlarged portion, the enlarged portion extends from the isthmus, the first protrusion is disposed on a non-horizontal-force-bearing side and the second protrusion is disposed on a horizontal-force-bearing side.

17. The dental implant according to claim 14, wherein the proximal plate-like projections comprises at least one upper proximal plate-like projection and at least one lower proximal plate-like projection, the central portion further comprises a third section, the upper proximal plate-like projection is disposed on the first section and the lower proximal plate-like projection is disposed on the third section.

18. The dental implant according to claim 14, wherein the proximal plate-like projections further comprise at least one pulling proximal plate-like projection, the length of the pulling proximal plate-like projection is higher than the other proximal plate-like projections, the pulling proximal plate-like projection has a pulling hole or a pulling groove.

19. A dental implant, comprising:
a central portion, having a first section, a second section, a horizontal direction and a vertical direction;
at least one fin, projecting from the second section of the central portion along the horizontal direction; and
at least one proximal plate-like projection, projecting from the first section of the central portion extending along the vertical direction, the proximal plate-like projection having at least one pulling proximal plate-like projection, the length of the pulling proximal plate-like projection being higher than the other proximal plate-like projections, the pulling proximal plate-like projection having a pulling hole or a pulling groove.

20. The dental implant according to claim 19, wherein the dental implant further comprises at least one protrusion, the protrusion is disposed on a clearance side of the first section, the clearance side without the proximal plate-like projection, the protrusion has an isthmus, the proximal plate-like projection is disposed on a proximal side of the first section, and the first section has a buccal clearance and a lingual clearance without the proximal plate-like projection, the protrusions are respectively disposed on a buccal side and a lingual side of the first section.

21. The dental implant according to claim 19, wherein the dental implant comprises a first protrusion and a second protrusion, the first protrusion comprises the isthmus and an enlarged portion, the enlarged portion extends from the isthmus, the first protrusion is disposed on a non-horizontal-force-bearing side and the second protrusion is disposed on a horizontal-force-bearing side.

22. The dental implant according to claim 19, wherein the proximal plate-like projection comprise at least one upper proximal plate is like projection and at least one lower proximal plate-like projection, the central portion further comprises a third section, the upper proximal plate-like projection is disposed on the first section and the lower proximal plate-like projection is disposed on the third section.

23. The dental implant according to claim 19, wherein the proximal plate-like projections comprise at least one positioning proximal plate-like projection, the proximal plate-like projection has a normal part and a lower part, the lower part of the positioning proximal plate-like projection extends outside the outer diameter of the fin.
